(19) United States
(12) Patent Application Publication
(10) Pub. No.: US 2009/0006650 A1
(43) Pub. Date: Jan. 1, 2009

(54) COMMUNICATION DEVICE, COMMUNICATION METHOD, COMMUNICATION INTERFACE, AND PROGRAM PRODUCT

(75) Inventor: Shiro SAITO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/163,481

(22) Filed: Jun. 27, 2008

(30) Foreign Application Priority Data
Jun. 28, 2007 (JP) 2007169866

(51) Int. Cl. G06F 15/16

(52) U.S. Cl. 709/245

(57) ABSTRACT

A communication device connected to a network includes a communication unit used for communications with the network, a data transmission unit that transmits data having a first address indicating the communication unit as a destination and a second address different from the first address as a source from the communication unit to the network, and a reply detection unit that receives the data returned from the network to the communication unit.

This application is based upon and claims the benefit of priority from Japanese patent application No. 2007-169866, filed on Jun. 28 2007, the disclosure of which is incorporated herein in its entirety by reference.

### BACKGROUND OF THE INVENTION

1. Field of the Invention

The present invention relates to a communication device connected to a network, and more particularly to a communication device that can detect link failure without depending on the type of a device that serves as a communication party.

2. Description of the Related Art

A related art will be described with reference to FIGS. 18 and 19.

FIG. 18 is a schematic diagram showing a network in which devices 1301 and 1302 are connected with each other. In this network, the device 1301 detects link failure by finding out whether a signal is physically inputted to the device 1301 from a signal transmission unit 1304 of the device 1302.

FIG. 19 shows a schematic diagram showing a system in which interconnected devices 1401 and 1402 exchange data with each other to detect link failure. The device 1401 transmits a confirmation request frame to the device 1402. On receiving the confirmation request frame, the device 1402 replies a confirmation response frame to the device 1401. The device 1401, when a confirmation response frame corresponding to the confirmation request frame does not arrive, determines that link failure occurs. Related arts are shown below:

[Patent Document 1] JP-A-2002-016664

[Patent Document 2] JP-A-2001-160825

In JP-A-2002-016664, a related art concerning an external loopback test method between communication devices is described.

In the related art, dedicated software is activated in both the devices that run an external loopback test. Then, a transmitting device transmits loopback test data of which destination and source are both the address of the transmitting device, to a receiving device. And, the dedicated software in the receiving device returns the loopback test data to the transmitting device. The transmitted loopback test data and the returned loopback test data are compared, and if no error is found, it is determined that a communication path between the devices is in order.

In JP-A-2001-160825, a related art of using an ICMP echo packet to detect a failure of a communication path between nodes is described.

The ICMP echo packet includes the IP address of the destination node of the packet and the IP address of the source of the packet. A node that has received the packet replies an ICMP echo reply to the IP address of the source. The node that has transmitted the ICMP echo packet detects a failure in a communication path between the nodes by the presence or absence of the ICMP echo reply.

In the related art shown in FIG. 18, when the signal transmission unit 1304 of the device 1302 is in order but the switch function unit 1303 fails, the device 1301 cannot detect link failure. This is because the device 1301 detects link failure when a physical input signal is absent, but, when the signal transmission unit 1304 is in order and an input signal to the device 1301 is not physically broken, the device 1301 cannot detect link failure.

In the related art shown in FIG. 19, to achieve a link failure detection method by the related art, both the devices 1401 and 1402 must have a function to transmit and receive confirmation request data and a function to determine link failure when confirmation response data for confirmation request data is not replied. Since these functions are not general-purpose functions, link failure can be detected by the method only in networks configured with devices having these functions.

In the related art described in JP-A-2002-016664, when an external loopback test is run, a dedicated program is required both in a side that transmits data for a loopback test and in aside that receives it. Therefore, a failure in a communication path can be detected by the related art only in networks configured with devices having the dedicated program.

In the related art described in JP-A-2001-160825, both the nodes that perform communications must have a function to transmit ICMP echo packets and ICMP echo reply. In short, unless both the nodes that perform communications have a specific function, a failure in a communication path cannot be detected by the related art.

### SUMMARY

An exemplary object of the present invention is to make it possible to detect link failure even when a physical link failure cannot be detected. Another exemplary object of the present invention is to make it possible to detect link failure without depending on the type of a communication device at the other end.

To achieve the above-described exemplary objects, a device according to an exemplary aspect of the invention transmits data having a first address indicating a communication unit used for communication with a network as a destination, and a second address different from the first address as a source to a net work from the communication unit, and receive data returned to the communication unit from the network.

### BRIEF DESCRIPTION OF THE DRAWINGS

FIG. 1 is a block diagram for explaining a first exemplary embodiment;

FIG. 2 is a drawing for explaining the structure of monitoring data in a first exemplary embodiment;

FIG. 3 is a block diagram for explaining a first exemplary embodiment;

FIG. 4 is a drawing for explaining a first exemplary embodiment;

FIG. 5 is a block diagram for explaining a first exemplary embodiment;

FIGS. 6A and 6B are drawings for explaining a first exemplary embodiment;

FIG. 7 is a drawing for explaining a first exemplary embodiment;

FIG. 8 is a sequence diagram for explaining a first exemplary embodiment;

FIG. 9 is a flowchart for explaining a first exemplary embodiment;

FIG. 10 is a block diagram for explaining a second exemplary embodiment;

FIG. 11 is a block diagram for explaining a third exemplary embodiment;

FIG. 12 is a block diagram for explaining a third exemplary embodiment;

FIG. 13 is a block diagram for explaining a fourth exemplary embodiment;

FIG. 14 is a block diagram for explaining a fourth exemplary embodiment;

FIG. 15 is a block diagram for explaining a fifth exemplary embodiment;

FIG. 16 is a block diagram for explaining a sixth exemplary embodiment;

FIG. 17 is a block diagram for explaining a sixth exemplary embodiment;

FIG. 18 is a drawing for explaining a related art; and

FIG. 19 is a drawing for explaining a related art.

### EXEMPLARY EMBODIMENT

Hereinafter, a first exemplary embodiment will be described with reference to the drawings. The following describes an example of an exemplary embodiment on a device that performs communications by the data link layer of an OSI reference model. However, the present invention is not limited to a device that performs communication by the data link layer of an OSI reference model.

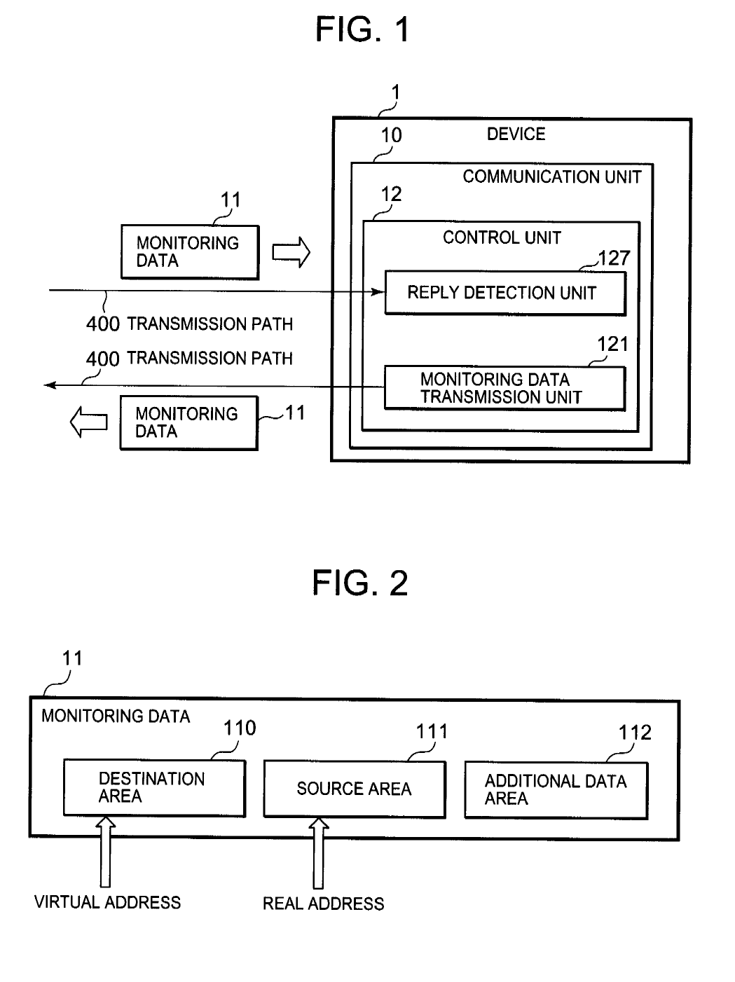

Referring to FIG. 1, a device 1 of this exemplary embodiment includes a communication unit 10 and a control unit 12. The control unit 12 includes a monitoring data transmission unit 121 and a reply detection unit 127. The device 1 is equipment used for communications with such as a switch, router, server, and host. In short, this exemplary embodiment does not depend on the type of equipment, and can apply to equipment used for communications. The device 1 connects with other devices such as a server and a switch by a transmission path 400. A virtual address corresponding to first information and a real address corresponding to second information are assigned to the communication unit 10.

A real address is, for example, a MAC address. A real address is used as an address (physical address) indicating the communication unit 10 of the device 1 when the device 1 performs communications with other equipment such as a server, a switch and so on.

A virtual address is, for example, a MAC address. Although a virtual address is different from a real address, it is an address indicating the communication unit 10 of the device 1 like a real address. A virtual address is an address used when the device 1 monitors a link state with other equipment such as a server, a switch and so on. In short, a virtual address is an address not used when the device 1 executes normal communications.

The communication unit 10 is, for example, a communication interface of the device 1. The communication unit 10 does transmission/reception of data with another communication device connected with the communication unit 10 via a network.

The control unit 12 transmits monitoring data 11, such as a layer 2 switch, used to monitor the states of links with other devices to a transmission path 400.

The following describes the monitoring data 11 with reference to FIG. 2.

The monitoring data 11 includes a destination area 110, source area 111, and additional data area 112. The monitoring data 11 is, for example, a frame in the data link layer of the OSI reference model.

In the destination area 110, the destination address of the monitoring data 11 is stored. The control unit 12 stores a virtual address in the destination area 110.

In the source area 111, the address of the source of the monitoring data 11 is stored. The control unit 12 stores a real address in the source area 111.

The control unit 12 may store a real address in the destination area 110, and a virtual address in the source area 111.

A virtual address stored in the destination area 110 and a real address stored in the source area 111 are different from each other, but both of them indicate the same device 1. For example, it is specified that a layer 2 switch discards the frame when it receives a frame storing an identical MAC address both in destination and source. In such case, a virtual address stored in destination area 110 and a real address stored in the source area 111 are required to be different from each other.

In the additional data area 112, arbitrary data, error detecting data for the monitoring data 11 (e.g., CRC value), and the likes are stored.

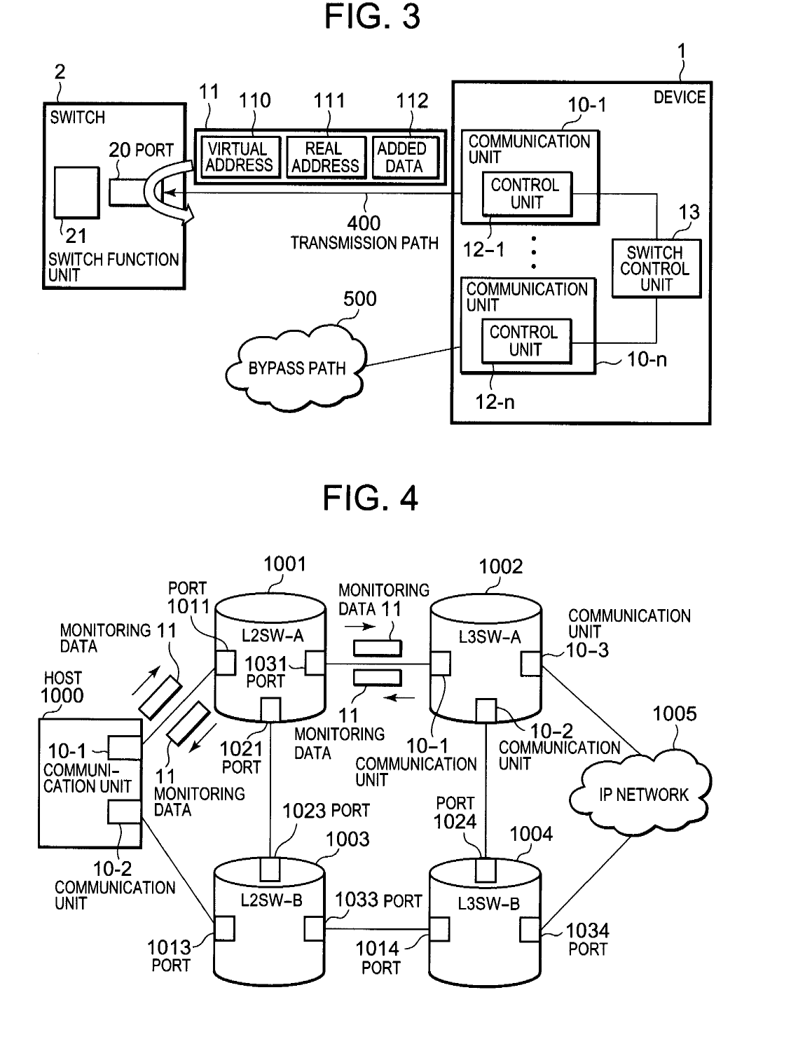

The following briefly describes the behavior of device 1 when it does transmission/reception of the monitoring data 11 with reference to FIGS. 3 and 4.

First, with reference to FIG. 3, the behavior of the device 1, when it does transmission/reception of the monitoring data 11 with another communication device connected with the communication unit 10 via a network.

The device 1 is connected with a switch 2, which is another communication device, via a transmission path 400. The switch 2 is, for example, layer 2 switch or layer 3 switch. The switch 2 includes port 20 and switch function unit 21. In FIG. 3, the switch 2 includes one port 20, but may include plural ports 20.

The switch function unit 21 performs transfer of frames received by the port 20 and so on. The switch function unit 21 has functions defined by specification of the data link layer of the OSI reference model.

The device 1 includes plural communication units 10 (10-1 to 10-n) and a switch function unit 13. However, the construction of the device 1 is not limited to it; the number of communication units 10 may be one, and the switch function unit 13 may not exist.

The switch function unit 13 performs transfer of frames received by the communication unit 10 and so on. The switch function unit 13, for example, has functions provided by specifications of the data link layer of the OSI reference model.

Each of the communication units 10(10-1 to 10-n) include control units 12 (12-1 to 12-n).

One or some of the communication units 10 (10-n in the case of FIG. 3) connect(s) with a bypass path 500. The bypass path 500 is a path for bypassing when a path from the device to the switch is out of order.

The control unit 12-1, to check the states of a link with the switch 2, transmits the monitoring data 11 at a specific cycle (hereinafter referred to as a monitoring data transmission cycle) to the switch 2. The cycle of transmitting the monitoring data 11 can be arbitrarily decided. The monitoring data transmission cycle may be set not to interfere with normal transmission of the device 1.

In the switch function unit 21 of the switch 2, the real address and virtual address of the communication unit 10-1 are already learned. This means that the real address and virtual address of the communication unit 10-1 are stored in a MAC address table of the switch function unit 21. The MAC address table is a table that, for each port of the switch, stores the MAC address of equipment connected to the port. In this case, in the MAC address table of the switch function unit 21, a port 20 is stored as ports corresponding to the real address and virtual address of the communication unit 10-1. The MAC address table of the switch function unit 21 may previously set the real address and virtual address of the communication unit 10-1. A general switch equipment has a function to statically register MAC addresses, and it may use this function. Or, according to a frame received by the switch 2, the MAC address table may be dynamically set. A method of dynamically setting the MAC address table will be described later.

The switch function unit 21 transfers received monitoring data 11 to the port 20 because an address stored in the destination area 110 of the received monitoring data 11 is a virtual address indicating the communication unit 10-1 of the device 1. Specifically, the monitoring data 11 transmitted from the control unit 12-1 returns again to the control unit 12-1 via the switch function unit 21 of the switch 2.

The control unit 12-1 determines that the link with the switch 2 is in order when the transmitted monitoring data 11 returns within a given time (hereinafter referred to as failure judgment reference time) The failure judgment reference time may be arbitrarily set. The failure judgment reference time may be set shorter than the monitoring data transmission cycle. If the failure judgment reference times is set shorter than the monitoring data transmission cycle, the transmission of other monitoring data 11, before the judgment by link failure by a certain monitoring data 11 is completed, is avoided. The control unit 12-1 determines that failure occurs in the link with the switch 2 when transmitted monitoring data 11 does not return within failure judgment reference time. On recognizing link failure, the control unit 12-1 commands the switch function unit 13 to switch a communication path from the transmission path 400 to the bypass path 500. On receiving the command from the control unit 12-1, the switch function unit 13 conducts switching to the bypass path 500.

With reference to FIG. 4, the following briefly describes the operation of the device 1 in a network system.

A network system shown in FIG. 4 includes host 1000, L2SW-A1001, L3SW-A1002, L2SW-B1003, L3SW-B1004, and IP network 1005. Assume that a host 1000 and L3SW-A1002 have the same construction as the device 1 of this exemplary embodiment. Other devices are assumed as general devices that perform communications based on the TCP/IP. It is apparent that the device 1 of this exemplary embodiment can operate in network systems other than the network system constructed as shown in FIG. 4.

A communication unit 10-1 of L3SW-A1002 includes a control unit 12-1. The communication unit 10-1 of the L3SW-A1002 corresponds to a communication port included in the L3SW-A1002. The control unit 12-1 of the L3SW-A1002 transmits the monitoring data 11 to the L2SW-A1001. The monitoring data 11 transmitted from the control unit 12-1 of the L3SW-A1002 is received in a port 1031 of the L2SW-A1001, forwarded in the L2SW-A1001, and transmitted from a port 1031 to the L3SW-A1002. On confirming that the monitoring data 11 has been returned within failure judgment reference time, the control unit 12-1 of the L3SW-A1002 recognizes that the link with the L2SW-A1001 is in order.

The communication unit 10-1 of a host 1000 includes a control unit 12-1. The communication unit 10-1 of the host 1000 corresponds to, for example, NIC (network interface card). The control unit 12-1 of the host 1000 transmits the monitoring data 11 to the L2SW-A1001. The monitoring data 11 transmitted from the control unit 12-1 of the host 1000 is received in a port 1011 of the L2SW-A1001, forwarded in L2SW-A1001, and transmitted from the port 1011 to the host 1000. On confirming that the monitoring data 11 has been returned within failure judgment reference time, the control unit 12-1 of the host 1000 recognizes that the link with the L2SW-A1001 is in order.

In this way, the host 1000 and the L3SW-A1002 can monitor the link with the adjacent equipment L2SW-A1001.

When no failure occurs in the communication paths, communication between the host 1000 and the IP network 1005 is performed in a path that reaches the IP network 1005 via the communication unit 10-1 of the host 1000, L2SW-A1001, and L3SW-A1002. The communication unit 10-2 of the host 1000 is a bypass path of the host 1000. The communication unit 10-2 of the L3SW-A1002 is a bypass path of the L3SW-A1002. In this case, when a fault occurs in the L2SW-A1001, the host 1000 and the L3SW-A1002 detect link failure, and respectively switch to a bypass path to perform communication. A bypass path when a fault occurs in the L2SW-A1001 is a path that reaches the IP network 1005 via the communication unit 10-2 of the host 1000, L2SW-B1003, L3SW-B1004, and L3SW-A1002.

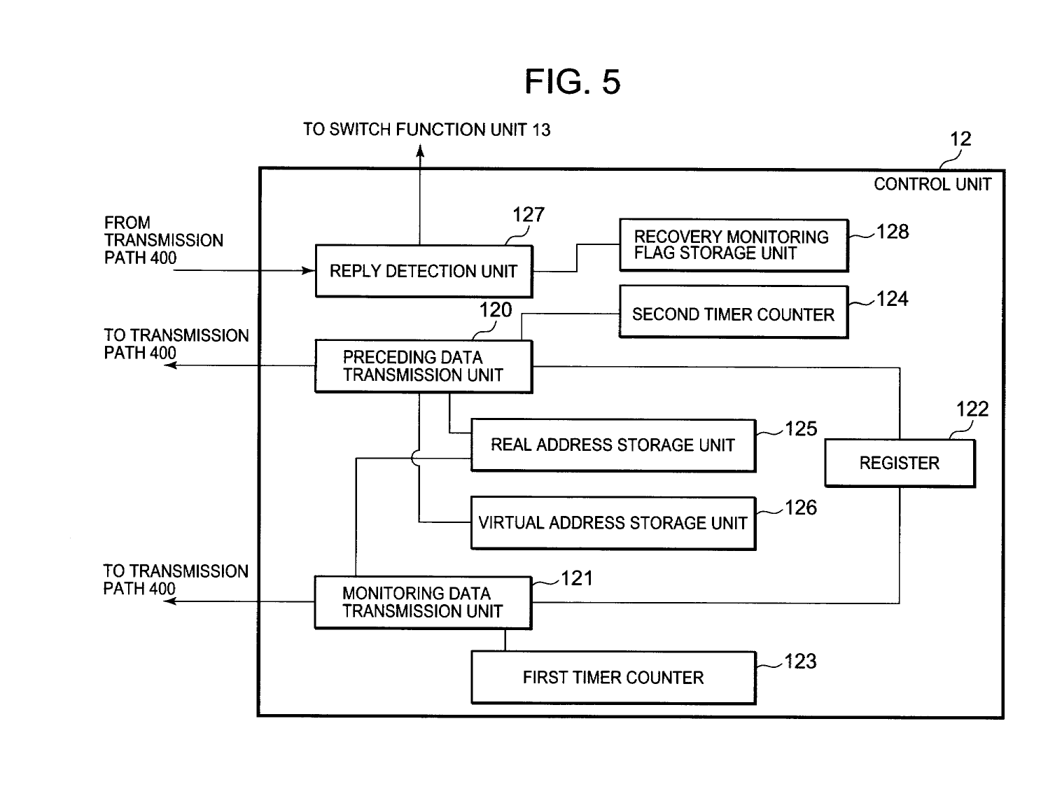

The following details the control unit 12 with reference to FIG. 5. FIG. 5 is an example of a functional block diagram of the control unit 12 of FIGS. 1 or 3.

The control unit 12 includes a preceding data transmission unit 120, monitoring data transmission unit 121, register 122, first timer counter 123, second timer counter 124, real address storage unit 125, virtual address storage unit 126, reply detection unit 127, and recovery monitoring flag storage unit 128.

The real address storage unit 125 stores a real address indicating the communication unit 10.

The virtual address storage unit 126 stores a virtual address indicating the communication unit 10.

The monitoring data transmission unit 121 refers to a real address stored in the real address storage unit 125 and a virtual address stored in the virtual address storage unit 126 to generate monitoring data 11. The monitoring data transmission unit 121 transmits the generated monitoring data 11 to the transmission path 400.

The first timer counter 123 counts monitoring data transmission cycles. For example, a value corresponding to the monitoring data transmission cycle is set as an initial value in the first timer counter 123, and is decremented every one clock cycle. When a set value has become “0,” the first timer counter 123 tells the monitoring data transmission unit 121 to transmit the monitoring data 11. After telling the monitoring data transmission unit 121, the first timer counter 123 returns the zero value to an original value to start counting again. The first timer counter 123 repeats these operations. As a result, the monitoring data 11 is transmitted from the monitoring data transmission unit 121 in a fixed cycle. A method of counting monitoring data transmission cycles by the timer counter 123 is not limited to the above-described method. For example, the method may be incrementing an initial value of “0” of the first timer counter 123 every one clock cycle.

The preceding data transmission unit 120 transmits preceding data 30 for learning a virtual address in a MAC address table of another communication device such as a switch. A virtual address is stored in the destination area of the monitoring data 11. Therefore, other communication devices such as a switch cannot send the monitoring data 11 back to the device 1 if the virtual address of the device 1 is not registered in the MAC address table. Therefore, when a virtual address is not registered in another communication device such as a switch in advance, a virtual address is required to be dynamically stored in the other communication device. According to the specification of the data link layer of the OSI reference model, the address of the source of a received frame is registered in the MAC address table in association with a port that received the frame. Therefore, the device 1 is required to transmit a frame containing a virtual address in an address of the source to another communication device before transmitting the monitoring data 11. Accordingly, the preceding data transmission unit 120 of the device 1 transmits preceding data 30 containing the virtual address as an address of the source to the other communication device.

The preceding data transmission unit 120 refers to a real address stored in the real address storage unit 125 and a virtual address stored in the virtual address storage unit 126 to generate preceding data 30. The preceding data transmission unit 120 generates preceding data 30 of which virtual address is the source of the preceding data 30 and of which real address as the destination of the preceding data, and transmits it to the transmission path 400. The destination address is designated as a real address with consideration of flooding. The “flooding” means, such a behavior as transferring the frame to all ports other than the port that received the frame when equipment such as a switch receives a frame having a broadcast address as a destination or a frame having an address of unknown destination not existing in the MAC address table as destination,. When a loop exists in the topology of a network to which a device such as a switch is connected, unless a switch or the like that can support STP (spanning tree protocol) exists in the network, a flooded frame triggers the depletion of a network band and causes a network failure. If the real address of the control unit 12 of the device 1 is not registered in the MAC address table of another communication device when transmitting the preceding data 30, flooding may occur. However, after transmitting the preceding data 30, monitoring data 11 of which real address is the source or normal communication data is transmitted from the device 1, and another communication device that received it registers the real address of the control unit 12 being the source of a received frame in the MAC address table. Therefore, the preceding data 30 looping through a communication path returns to the device 1 anyway. As a result, a network failure due to flooding can be avoided.

The preceding data transmission unit 120, after transmitting the preceding data 30, stores in the register 122 information indicating that the preceding data 30 has been transmitted. The register 122 stores information indicating whether the preceding data has been transmitted, for example, by one-bit flag.

The monitoring data transmission unit 121 checks the content of the register 122 before transmitting the monitoring data 11. The monitoring data transmission unit 121, when the content of the register indicates that the preceding data has been transmitted, transmits the monitoring data 11 to the transmission path 400.

The second timer counter 124 is a timer for counting cycles (hereinafter, referred to as preceding data cycles) in which the preceding data transmission unit 120 transmits the preceding data 30. The second timer counter 124 is used to cope with the aging of the MAC address table. According to some specifications, a MAC address registered in a MAC address table of another communication device such as a switch may be deleted from the table if communication for the MAC address does not occur for a specific time. This is called as aging. This function is intended to prevent from unnecessarily extending search time due to a huge number of entries of the MAC address table. Given that the preceding data transmission unit 120 transmits the preceding data only one time, because of the aging of the MAC address table of the other communication device, a registered virtual address of the control unit 12 may be deleted. If the virtual address of the communication unit 10 is deleted from the MAC address table of another communication device, monitoring data 11 which is subsequently received may be unable to be sent back to the device 1. Therefore, the preceding data transmission unit 120 may transmit preceding data periodically so that a registered virtual address may not be subjected to aging. Specifically, the second timer counter 124 may hold a cycle shorter than the cycle of aging as a preceding data transmission cycle. The second timer counter 124 counts preceding data transmission cycles, and notifies the preceding data transmission unit 120 of the timing of transmitting the preceding data 30. A method by which the second timer counter 124 counts preceding data transmission cycles may be the same as that of the first timer counter 123. When the preceding data transmission unit 120 cannot transmit the preceding data 30 within a preceding data transmission cycle for some cause such as a failure, the content of the register 122 may be updated to a content indicating that the preceding data 30 is not transmitted.

The reply detection unit 127 determines whether the monitoring data 11 has been returned from another communication device. The reply detection unit 127 determines whether the link is in order or out of order, according to whether the monitoring data 11 has been returned within failure judgment reference time. The reply detection unit 127, when detecting link failure, commands the switch function unit 13 to switch a path where communication is executed to a bypass path. If the switch function unit 13 does not exist in the device 1, the reply detection unit 127 may make no notification about it. The reply detection unit 127, when detecting a link failure, notifies the OS, middleware, application, and the like that a link failure is detected.

After the reply detection unit 127 detects link failure link, the preceding data transmission unit 120 and the monitoring data transmission unit 121 may continue to transmit the preceding data 30 and the monitoring data 11 respectively. In this case, when it is confirmed that the monitoring data 11 has been replied a specific number of times (hereinafter, referred to as link failure recovery reference), the reply detection unit 127 determines that link failure has been recovered. As the link failure recovery reference, any number may be set. The reply control unit 127, when continuing to transmit the preceding data 30 and the monitoring data 11 also after detecting link failure, turns on the recovery monitoring flag stored in the recovery monitoring flag storage unit 128. As long as the recovery monitoring flag of the recovery monitoring flag storage unit 128 is on, the reply detection unit 127 checks the reply of the monitoring data 11 and determines whether the number of replies of the monitoring data 11 has reached the link failure recovery reference. The reply detection unit 127, when the number of replies of the monitoring data 11 has reached the link failure recovery reference, commands the switch function unit 13 to switch a path where communication is executed from a bypass path to a route before link failure detection. When the switch function unit 13 does not exist in the device 1, the reply detection unit 127 may make no notification about it. The reply detection unit 127, when the number of replies of the monitoring data 11 has reached the link failure recovery reference, turns off the recovery monitoring flag stored in the recovery monitoring flag storage unit 128. The initial value of the recovery monitoring flag stored in the recovery monitoring flag storage unit 128 is off.

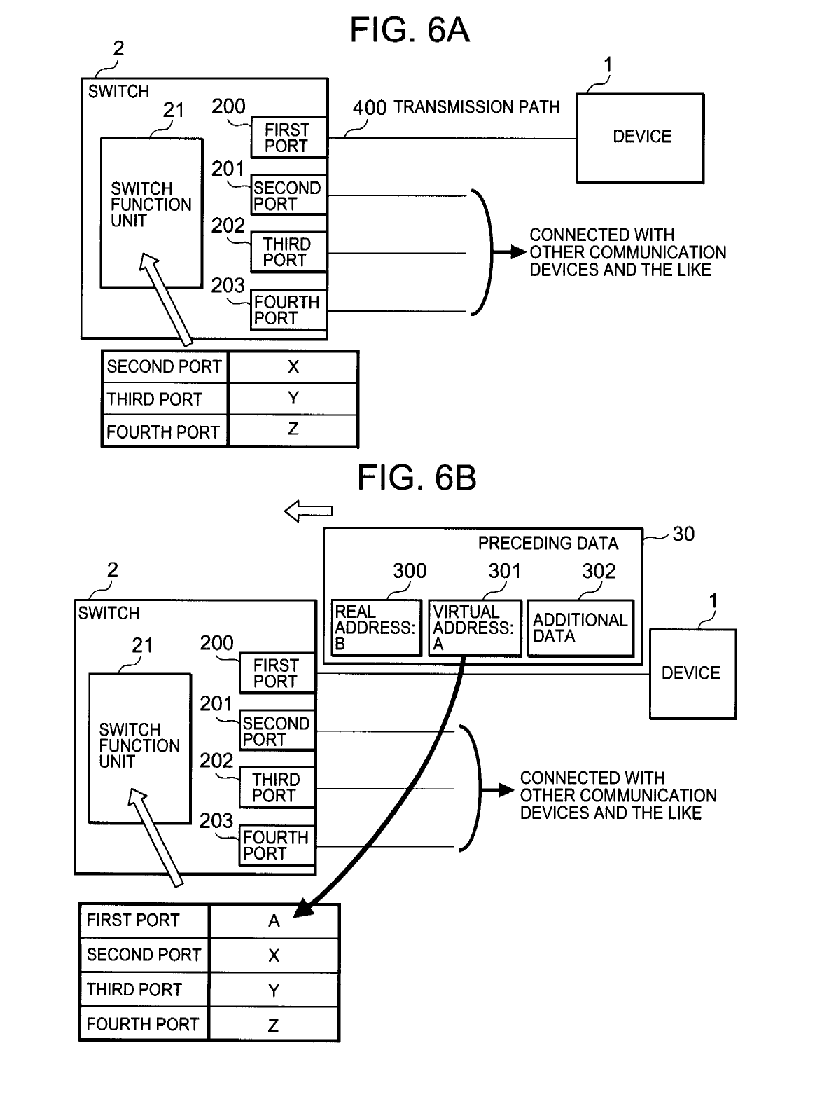

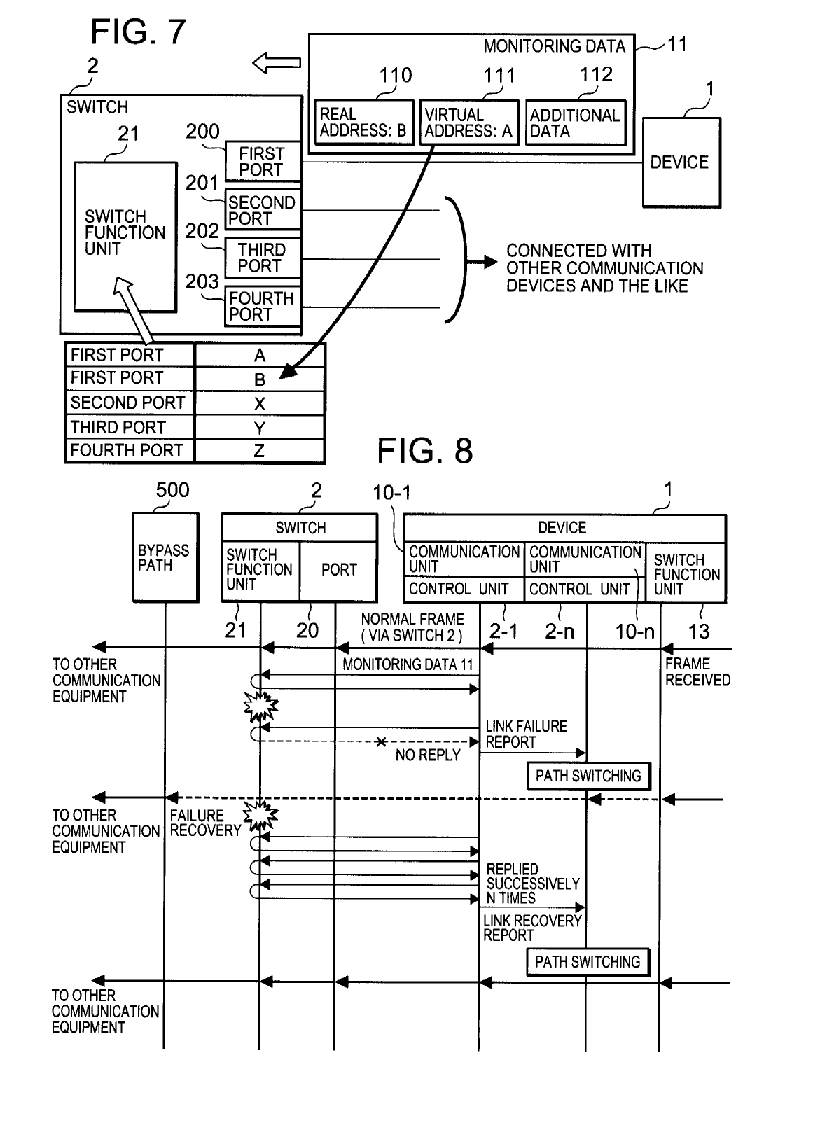

The following describes the operation of registering a virtual address in a MAC address table of another communication device with reference to FIGS. 6A, 6B, and 7.

FIG. 6A shows that the device 1 of this exemplary embodiment and another communication device, the switch 2, are connected, and a virtual address and a physical address of the communication unit 10 of the device 1 are not registered in the MAC address table of the switch 2. Second to fourth ports of the switch 2 are connected with other communication devices than the device 1, and a MAC addresses (X, Y, Z) of the devices are registered in the MAC address table.

In this state, preceding data 30 is transmitted from the control unit 12 of the device 1. This state is shown in FIG. 6B. The virtual address (A) of the communication unit 10 is stored in the source address of the preceding data 30. The switch 2 receives the preceding data 30 from the first port. The switch function unit 21 of the switch 2 creates a new entry, in the MAC address table, with the virtual address (A) of the source address of the received preceding data 30 associated with the number of a port (first) that received the preceding data 30.

Next, the control unit 12 of the device 1 transmits monitoring data 11. This state is shown in FIG. 7. The real address (B) of the communication unit 10 is stored in the source address of the monitoring data 11. The switch 2 receives the monitoring data 11 from the first port. The switch function unit 21 of the switch 2 creates a new entry, in the MAC address table, with the real address (B) of the source address of the received monitoring data 11 associated with the number (first) of a port that received the monitoring data 11.

In this way, the real address and the virtual address of the communication unit 10 of the device 1 are registered in the MAC address table of switch 2.

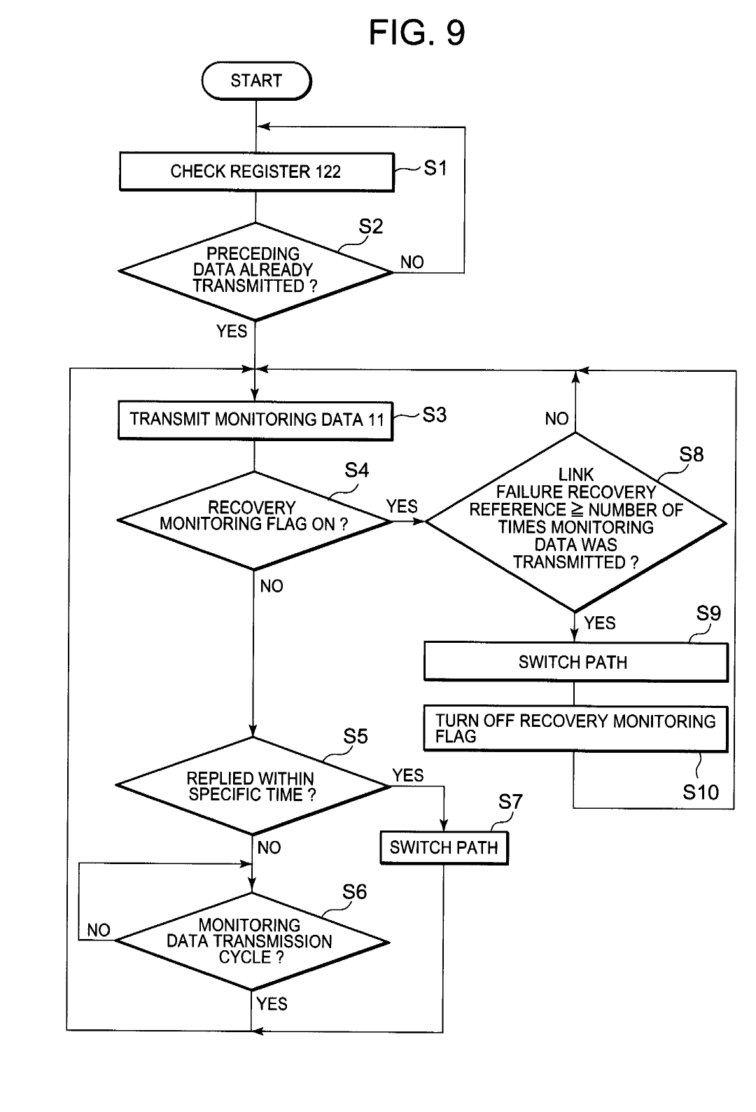

The following describes the operation of the device 1 with reference to a sequence diagram of FIG. 8 and a flowchart of FIG. 9.

First, a description is made with reference to a sequence diagram of FIG. 8.

One or some of the communication units 10 receive(s) a frame transmitted from the outside. The received frame is forwarded in the switch function unit 13 of the device 1, and transmitted from the communication unit 10-1 to the port 20 of the switch 2. The frame received in the port 20 of the switch 2 is forwarded by the switch function unit 21, and transmitted from another port of the switch 2 to another telecommunication equipment.

The control unit 12-1 of the device 1 transmits monitoring data 11. When receiving the monitoring data 11, the switch function unit 21 of the switch 2 checks the destination address of the monitoring data 11. Since the virtual address of the communication unit 10-1 is stored in the destination address of the monitoring data 11, the switch function unit 21 sends back the monitoring data 11 from the port 20 to the control unit 12-1 of the device 1.

The control unit 12-1 may perform nothing when the monitoring data 11 returns within the failure judgment reference time. When the monitoring data 11 does not return within the failure judgment reference time, the control unit 12-1 determines that link failure occurs. The control unit 12-1 commands the switch function unit 13 to change the communication path. On receiving the command, the switch function unit 13 changes the communication path. As a result, the frame received by the device 1 is transmitted from a communication unit 10-n to other communication equipment via the bypass path 500.

On the other hand, the control unit 12-1 continues to transmit the monitoring data 11 even after detecting link failure, and monitors the recovery of the switch 2. When the number of times the monitoring data 11 is returned from the switch 2 reaches link failure reference, the control unit 12-1 determines that link failure has been recovered. When the link failure is recovered, the control unit 12-1 commands the switch function unit 13 to return the communication path to the state in which it was before detecting link failure. On receiving the command, the switch function unit 13 returns the communication path to the state before detecting link failure.

The following details the operation of the device 1 with reference to a flowchart of FIG. 9.

The monitoring data transmission unit 121 of the control unit 12 checks the content of the register 122 (S1).

When the content of the register 122 indicates that the preceding data 30 is not transmitted, the monitoring data transmission unit 121 of the control unit 12 waits until the content of the register 122 is updated to indicate that the preceding data has been transmitted (No in S2). The monitoring data transmission unit 121 may check the content of the register 122 at a fixed time interval. In the interval, the preceding data transmission unit 120 transmits the preceding data 30.

When the content of the register 122 indicates that the preceding data 30 has been transmitted (Yes in S2), the monitoring data transmission unit 121 of the control unit 12 transmits the monitoring data 11 (S3).

The reply detection unit 127 of the control unit 12 checks the content of the recovery monitoring flag storage unit 128 (S4).

When the recovery monitoring flag stored in the recovery monitoring flag storage unit 128 is off (No in S4), the reply detection unit 127 of the control unit 12 monitors whether the monitoring data 11 has been returned within the failure judgment reference time (S5). When the monitoring data 11 has been returned within the failure judgment reference time, the reply detection unit 127 determines that the link is in order (Yes in S5). When the monitoring data 11 is not within the failure judgment reference time, the reply detection unit 127 determines that the link is out of order (No in S5). When the device 1 includes the switch function unit 13, the reply detection unit 127 commands the switch function unit 13 to change the communication path to a bypass path (S7).

When the monitoring data transmission unit 121 receives notification, from the first timer counter 123, indicating that a monitoring data transmission cycle has been reached (Yes in S6), the monitoring data transmission unit 121 transmits the monitoring data 11. As long as the information does not arrive from the first timer counter 123 (No in S6), the monitoring data transmission unit 121 waits to receive the information.

When the recovery monitoring flag stored in the recovery monitoring flag storage unit 128 is on (Yes in S4), the reply detection unit 127 monitors whether the number of times the S monitoring data 11 is replied has reached the link failure recovery reference (S8).

When the number of times the monitoring data 11 is replied has reached the link failure recovery reference (Yes in S8), the reply detection unit 127 commands the switch function unit 13 to return the communication path to a path before link failure is detected (S9). When the device 1 does not include the switch function unit 13, the reply detection unit 127 may not perform the processing.

When the number of times the monitoring data 11 is replied reaches the link failure recovery reference (Yes in S8), the reply detection unit 127 turns off the recovery monitoring flag stored in recovery monitoring flag storage unit 128 (S10).

The control unit 12 repeats the above operation when the device 1 is operating.

As has been described above, in this exemplary embodiment, data using a first address indicating a communication unit used for communication with a network as a destination and using a second address different from a first address as a source, is transmitted from the communication unit to a network, and the data returned to the communication unit from the network is received.

Since the communication unit of a device that transmits the data is used as the destination of the data, the data transmitted from the device of this exemplary embodiment returns again to the device of this exemplary embodiment by a data transfer function included in another communication device connected with S the communication unit of the device of this exemplary embodiment via a network. Therefore, the device of this exemplary embodiment, when received data cannot be returned to the device of this exemplary embodiment due to a failure occurs in a portion that controls the data transfer function in the other communication device connected with the communication unit via the network, can detect the failure of link with the other communication device.

Specifically, the device of this exemplary embodiment can detect link failure even when a failure of a physical link with another communication device cannot be detected.

Moreover, since the device of this exemplary embodiment transmits data of which destination is the device itself and detects link failure by determining whether the data has been replied to the device itself by a switching function generally included in another communication device, it need not transmit and receive a special frame to and from the other communication device. Furthermore, since data transmitted by the device of this exemplary embodiment is not such special data as its destination and source are same, it is not required to perform special software processing each other between another communication device. In short, link failure can be detected without adding special functions to the other communication device.

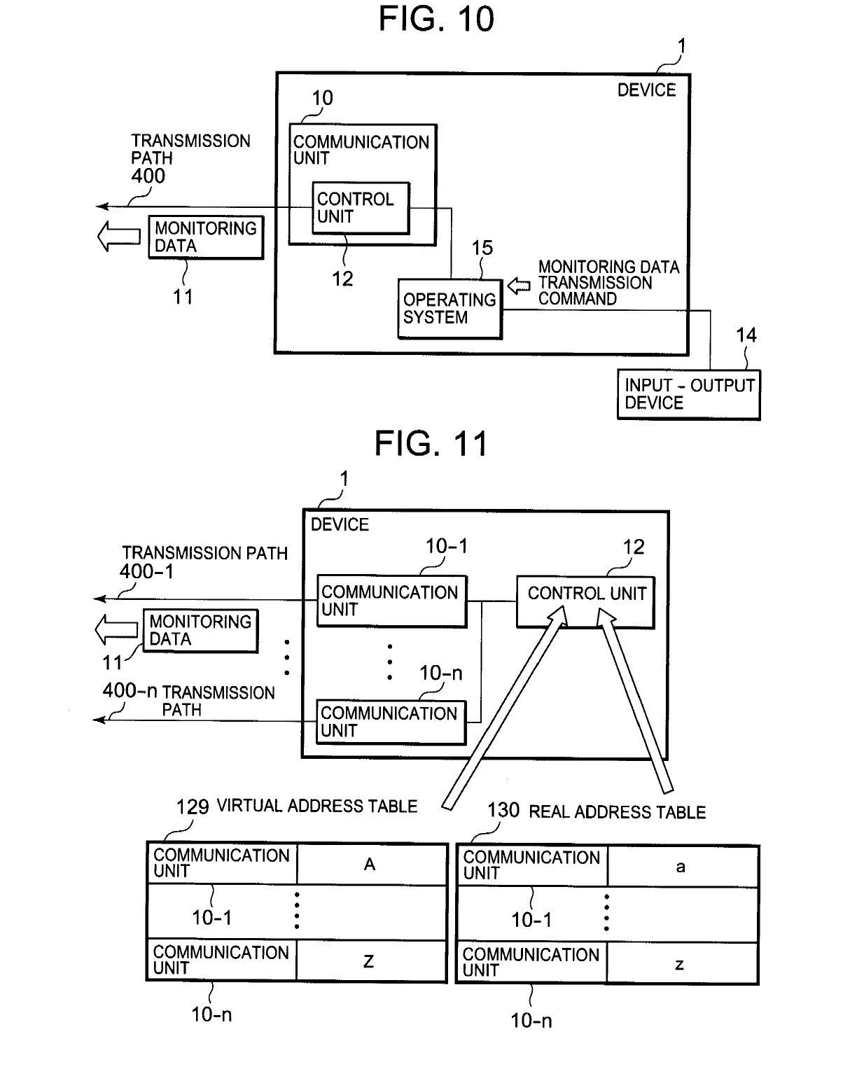

The following describes a second exemplary embodiment with reference to FIG. 10.

The control unit 12 of the device 1 in this exemplary embodiment can transmit monitoring data 11 at arbitrary time.

Referring to FIG. 10, the control unit 12 of the device 1 of this exemplary embodiment is constructed to accept input from an input-output device 14. The input-output device 14 is, for example, a keyboard. The input-output device 14 includes a display unit such as a console. The control unit 12, for example, accepts input from the input-output device 14 via the operating system 15 of the device 1. The control unit 12 is constructed to accept a command (hereinafter referred to as a monitoring data transmission command) for commanding the transmission of the monitoring data 11. For example, a user of the device 1 inputs the monitoring data transmission command by a keyboard being an example of the input-output device 14. Also, for example, a user of the device 1 inputs the monitoring data transmission command by pressing a button being an example of the input-output device 14. When the monitoring data transmission command is inputted from the input-output device 14 via the operating system 15, the monitoring data transmission unit 121 of the control unit 12 transmits the monitoring data 11 to the transmission path 400. However, if the preceding data 30 is not transmitted when the monitoring data transmission command has been inputted, the monitoring data transmission unit 121 of the control unit 12 waits for the preceding data 30 to be transmitted before transmitting the monitoring data 11.

On accepting the monitoring data transmission command, the reply detection unit 127 of the control unit 12 monitors whether the monitoring data has been returned within the failure judgment reference time. The reply detection unit 127 indicates the result of monitoring to the input-output device 14. The control unit 12, for example, indicates the result of monitoring by text to a console being an example of the input-output device 14. The control unit 12, for example, indicates the result of monitoring by a LED lamp being an example of the input-output device 14. In this case, for example, the color of the LED lamp may be changed at the time of link failure.

According to the second exemplary embodiment described above, advantageously, the function of the control unit 12 can apply to state checking after construction such as the expansion of a network system and cable laying.

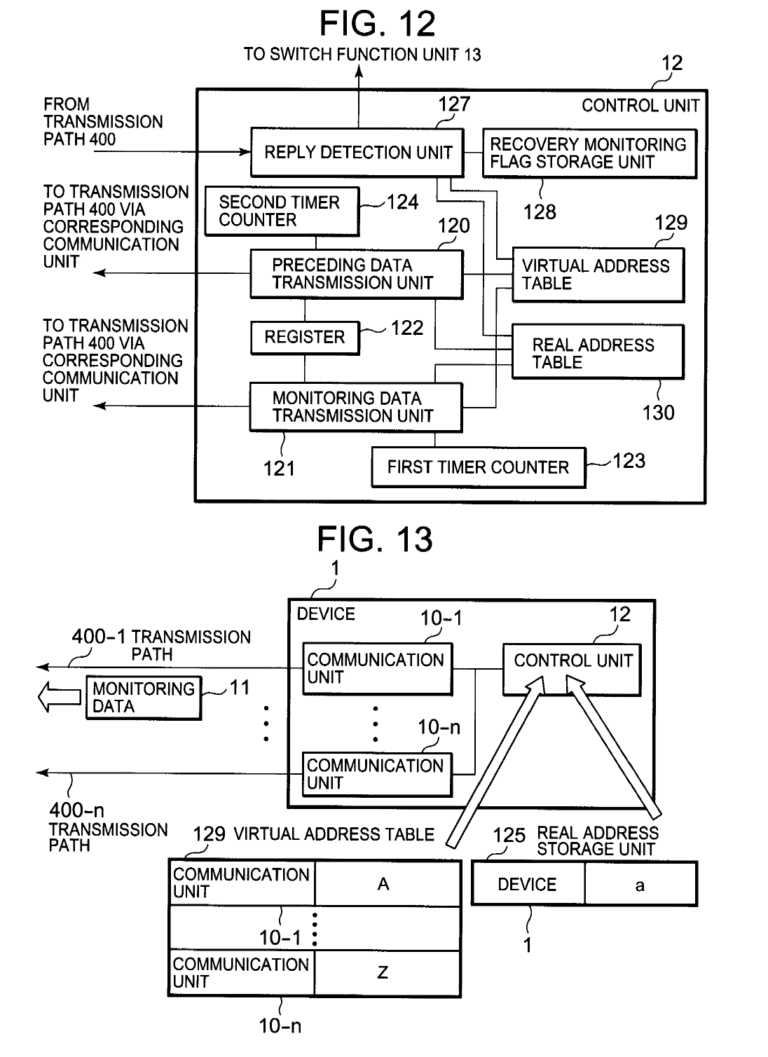

The following describes a third exemplary embodiment with reference to FIGS. 11 and 12.

A device 1 of this exemplary embodiment has one control unit 12.

As shown in FIG. 11, the control unit 12 in the device 1 of this exemplary embodiment includes a virtual address table 129 that registers the respective virtual addresses of communication units 10-1 to 10-n, and a real address table 130 that registers the respective real addresses of the communication units 10-1 to 10-n.

FIG. 12 shows an example of a functional block diagram of the control unit 12 in this exemplary embodiment.

The virtual address table 129 and the real address table 130 are connected to each of a preceding data transmission unit 120, a monitoring data transmission unit 121, and a reply detection unit 127. Other constructions are the same as those of FIG. 5; a description of them is omitted.

The preceding data transmission unit 120 extracts a virtual address and a real address, which corresponds to a communication unit 10 (one of the communication units 10-1 to 10-n) that transmits preceding data 30, from the virtual address table 129 and the real address table 130. The preceding data transmission unit 120 generates preceding data 30 from the extracted virtual address and real address, and transmits it to the transmission path 400 via a corresponding communication unit 10 (one of 10-1 to 10-n).

The second timer counter 124 is constructed to count preceding data transmission cycles for each of the communication units 10. In short, the second timer counter 124 has as many timer counters as the number of communication units 10. The second timer counter 124 may be set so that the preceding data transmission cycles of each of the communication units 10 may not be the same timing. The second timer counter 124 notifies the preceding data transmission unit 120 each time a preceding data transmission cycle corresponding to each communication unit 10 comes. On receiving the notification, the preceding data transmission unit 120 generates preceding data 30 for a corresponding communication unit 10, and transmits the preceding data 30 via the corresponding communication unit (one of the communication units 10-1 to 10-n).

The register 122 stores information, for each of the communication units 10, indicating whether the preceding data 30 has been transmitted. In short, the register 122 has as many entries as the number of communication units 10. The preceding data transmission unit 120 stores information indicating that the preceding data 30 has been transmitted, in an entry corresponding to a communication unit 10 (one of the communication units 10-1 to 10-n) targeted for the transmission of the preceding data 30.

The monitoring data transmission unit 121 extracts a virtual address and a real address, which corresponds to a communication unit 10 (one of the communication units 10-1 to 10-n) that transmits monitoring data 11, from the virtual address table 129 and the real address table 130. The monitoring data transmission unit 121 generates monitoring data 11 from the extracted virtual address and real address, and transmits it to the transmission path 400 via a corresponding communication unit 10 (one of 10-1 to 10-n).

The monitoring data transmission unit 121 checks the content of a register 122 corresponding to a communication unit 10 (one of the communication units 10-1 to 10-n) targeted for the transmission of monitoring data 11. When the content of the entry indicates that the preceding data 30 has been transmitted, the monitoring data transmission unit 121 transmits the monitoring data 11.

The first timer counter 123 is constructed to count monitoring data transmission cycles for each of the communication units 10. In short, the first timer counter 123 has as many timer counters as the number of communication units 10. The first timer counter 123 may be set so that the monitoring data transmission cycles of each of the communication units 10 may not be the same timing. The first timer counter 123 notifies the monitoring data transmission unit 121 each time a monitoring data transmission cycle corresponding to each communication unit 10 comes. On receiving the notification, the monitoring data transmission unit 121 generates monitoring data 11 for a corresponding communication unit 10, and transmits the monitoring data 11 via the corresponding communication unit (one of the communication units 10-1 to 10-n).

The reply detection unit 127 confirms a virtual address contained in the destination area 110 and a real address contained in the source area 111 of the returned monitoring data 11, refers to the virtual address table 129 and the real address table 130, and determines from which communication unit 10 the monitoring data 11 has been transmitted. Thereby, the reply detection unit 127 can monitor link failure for each of the communication units 10. The reply detection unit 127 may use one of the virtual address or real address contained in the returned monitoring data 11 to determine a communication unit 10 from which the monitoring data 11 has been transmitted.

The recovery monitoring flag storage unit 128 has a recovery monitoring flag, for each of the communication units 10, indicating that link failure is detected and the recovery of the link is being monitored. Thereby, the reply detection unit 127 can monitor recovery for each of the communication units 10.

According to the third exemplary embodiment described above, since the control unit 12 is not required to be provided for each of the communication units 10, areas for installing hardware resources corresponding to the control unit 12 can be saved.

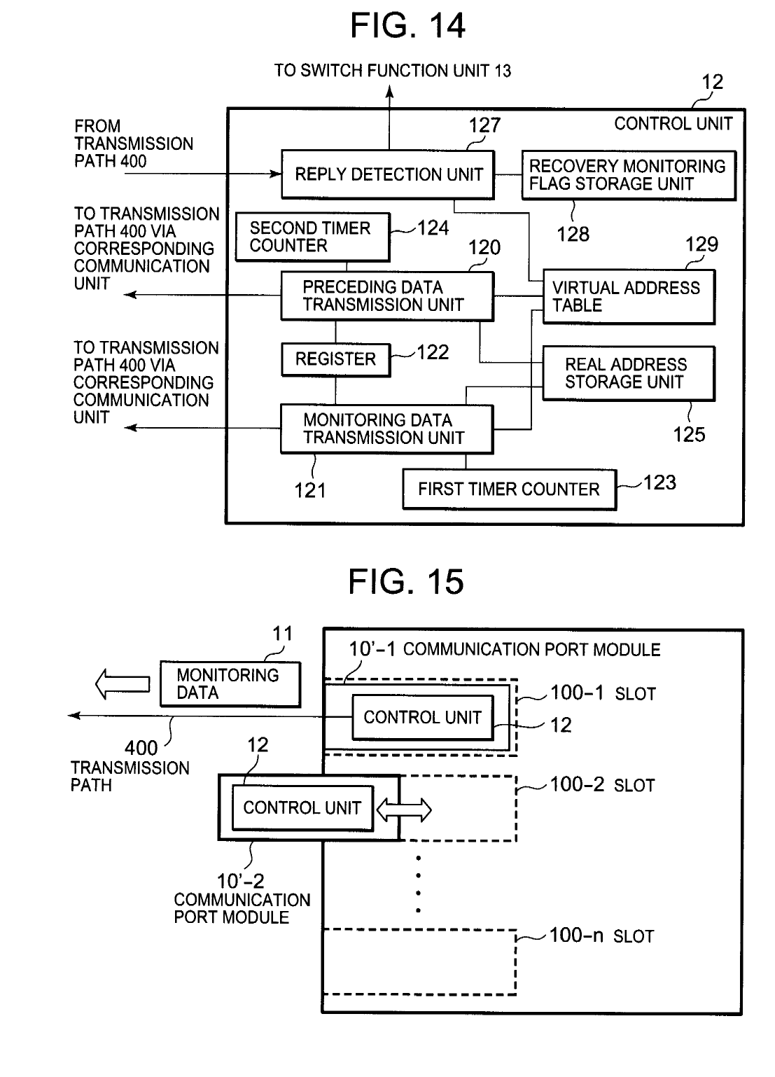

The following describes a fourth exemplary embodiment with reference to FIGS. 13 and 14.

The device 1 of this exemplary embodiment includes one control unit 12, and the control unit 12 includes a virtual address table 129 that stores virtual addresses corresponding to each of communication units 10, and a real address storage unit 125 that stores a real address corresponding to the device 1 itself.

As shown in FIG. 13, the control unit 12 in the device 1 of this exemplary embodiment includes a virtual address table 129 that registers the respective virtual addresses of the communication units 10-1 to 10-n, and a real address storage unit 125 that stores a real address corresponding to the device 1. It is assumed that the device 1 of this exemplary embodiment is equipment of which principal function is data transfer, such as a switch and a router. A device such as a switch or a router is not required to positively execute communication with data such as a MAC frame by themselves, like NIC (network interface card) of host. Therefore, it is not required to have a real address, used during executing communication, for each of the communication units 10.

FIG. 14 shows an example of a function block diagram of the control unit 12 in this exemplary embodiment.

The virtual address table 129 is connected to each of the preceding data transmission unit 120, the monitoring data transmission unit 121, and the reply detection unit 127. Other constructions are the same as those of FIG. 5; a description of them is omitted.

The preceding data transmission unit 120 extracts a virtual address, which corresponds to a communication unit 10 (one of the communication units 10-1 to 10-n) that transmits preceding data 30, from the virtual address table 129. The preceding data transmission unit 120 generates preceding data 30 from the extracted virtual address and a real address stored in the real address storage unit 125, and transmits the preceding data 30 to the transmission path 400 via a corresponding communication unit (one of 10-1 to 10-n).

The second timer counter 124 is constructed to count preceding transmission cycles for each of the communication units 10. In short, the second timer counter includes as many timer counters as the number of communication unit 10. The second timer counter 124 may be set so that the preceding data transmission cycles of each of the communication units 10 may not be the same timing. The second timer counter 124 notifies the preceding data transmission unit 120 each time a preceding data transmission cycle corresponding to each communication unit 10 comes. On receiving the notification, the preceding data transmission unit 120 generates preceding data 30 for a corresponding communication unit 10, and transmits the preceding data 30 via the corresponding communication unit (one of the communication units 10-1 to 10-n).

The register 122 stores information, for each of the communication units 10, indicating whether the preceding data 30 has been transmitted. In short, the register 122 has as many entries as the number of communication units 10. The preceding data transmission unit 120 stores information indicating that the preceding data 30 has been transmitted, in an entry corresponding to a communication unit 10 (one of the communication units 10-1 to 10-n) targeted for the transmission of the preceding data 30.

The monitoring data transmission unit 121 extracts a virtual address, which corresponds to a communication unit (one of the communication units 10-1 to 10-n), from the virtual address table 129. The monitoring data transmission unit 121 generates monitoring data 11 from the extracted virtual address and a real address stored in the real address storage unit 125, and transmits it to the transmission path 400 via a corresponding communication unit (one of 10-1 to 10-n).

The monitoring data transmission unit 121 checks the content of a register 122 corresponding to a communication unit 10 (one of the communication units 10-1 to 10-n) targeted for the transmission of monitoring data 11. When the content of the entry indicates that the preceding data 30 has been transmitted, the monitoring data transmission unit 121 transmits the monitoring data 11.

The first timer counter 123 is constructed to count monitoring data transmission cycles for each of the communication units 10. In short, the first timer counter 123 has as many timer counters as the number of communication units 10. The first timer counter 123 may be set so that the monitoring data transmission cycles of each of communication units 10 may not be the same timing. The first timer counter 123 notifies the monitoring data transmission unit 121 each time a monitoring data transmission cycle corresponding to each communication unit 10 comes. On receiving the notification, the monitoring data transmission unit 121 generates monitoring data 11 for a corresponding communication unit 10, and transmits the monitoring data 11 via the corresponding communication unit (one of the communication units 10-1 to 10-n).

The reply detection unit 127 confirms a virtual address contained in the destination area 110 of the returned monitoring data 11, refers to the virtual address table 129, and determines from which communication unit 10 the monitoring data 11 has been transmitted. Thereby, the reply detection unit 127 can monitor link failure for each of the communication units 10.

The recovery monitoring flag storage unit 128 has a recovery monitoring flag, for each of the communication units 10, indicating that link failure is detected and the recovery of the link is being monitored. Thereby, the reply detection unit 127 can monitor recovery for each of the communication units 10.

According to the fourth exemplary embodiment described above, since a real address is not required to be stored for each of the communication units 10, the capacity to store real addresses can be saved.

The following describes a fifth exemplary embodiment with reference to FIG. 15.

In this exemplary embodiment, a communication interface such as communication port modules and NIC (network interface card) is provided with the control unit 12.

The device 600 is a device that performs communications, such as a server, host, switch, or router.

The device 600 includes slots 100-1 to 100-n to insert a communication port module 601 (any one of communication port modules 601-1 to 601-n). The communication port module 601 is, for example, a communication interface module for expanding ports of a switch or router. Also, the communication port module 601 is, for example, NIC or the like of a server and host. The communication port module 601 is not limited to these, and may be any of communication interfaces expandable to devices that perform communication.

Each of the communication port modules 601 includes a control unit 12.

According to the fifth exemplary embodiment described above, by expanding unit of communication interface such as communication port module or NIC, functions realized by the present invention can be enjoyed without expanding the device 1 itself of the above-described exemplary embodiment.

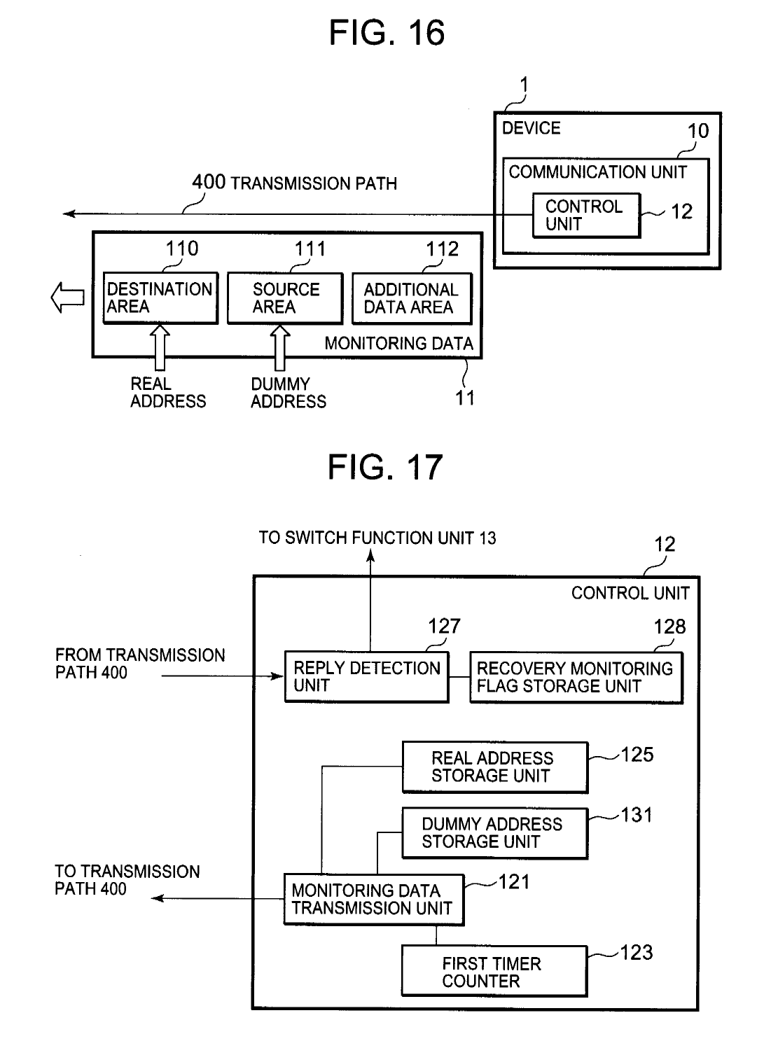

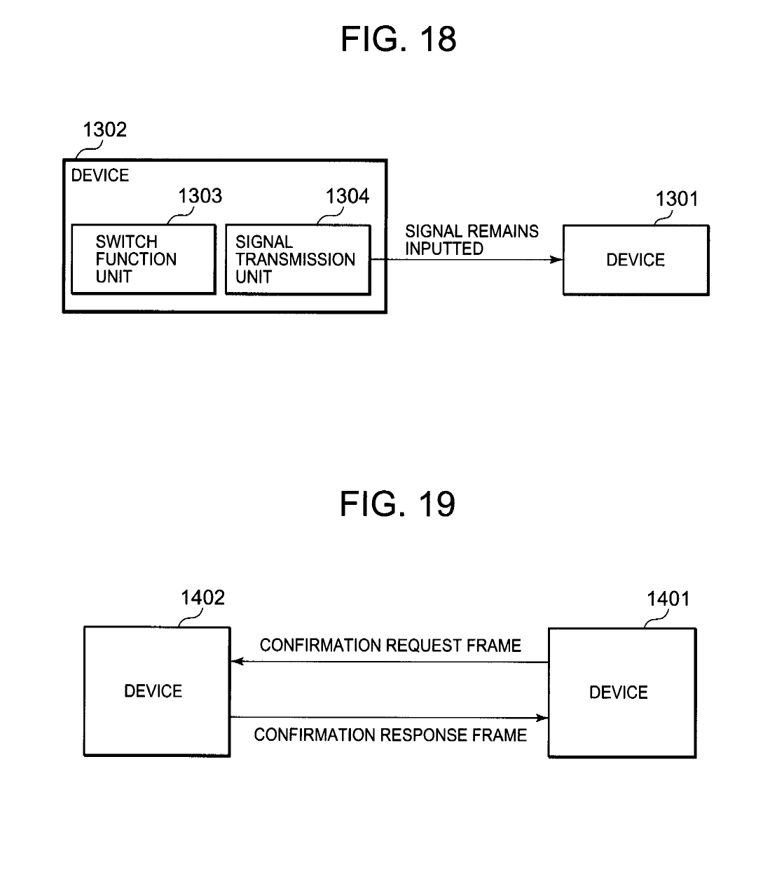

The following describes a sixth exemplary embodiment with reference to FIGS. 16 and 17.

In this embodiment, the device 1, as shown in FIG. 16, stores a real address in the destination area 110 of the monitoring data 11, and stores a dummy address in the source area 111.

The dummy address is, for example, a MAC address, and different from a real address. However, the dummy address may be any of absolute addresses different from an address of another communication device connected with the communication unit 10 via a network, and need not be used as address indicating the communication unit 10 of the device 1. This point is different from virtual addresses described in other exemplary embodiments.

For example, a unique and absolute MAC address (physical address) is required to be stored in the address field of the source of a MAC frame defined in the specifications of the data link layer of the OSI reference model. Therefore, dummy addresses in this exemplary embodiment may also be required to be absolute addresses different from addresses of all of other communication devices than the device 1. A real address is used as an address (physical address) indicating the communication unit 10 of the device 1 when the device 1 communicates with another communication device, while a dummy address is used for the monitoring data 11 and not used in other cases.

In the destination area 110 of the monitoring data 11 of this exemplary embodiment, a real address (physical address) corresponding to one for one with each of the communication units 10 of the device 1 is stored. Therefore, like other exemplary embodiments, the monitoring data 11 in this exemplary embodiment is transmitted from the device 1, and returns to the device 1 again. Moreover, since a dummy address stored in the source area 111 of the monitoring data 11 of this exemplary embodiment is different from a real address, the monitoring data 11 is not discarded on another communication device.

The control unit 12 in the exemplary embodiment will be described with reference to FIG. 17.

The control unit 12 of this exemplary embodiment includes a dummy address storage unit 131. Other components are the same as those described in other exemplary embodiments.

The dummy address storage unit 131 stores a dummy address.

The monitoring data transmission unit 121 generates monitoring data 11 from a real address stored in the real address storage unit 125 and a dummy address stored in the dummy address storage unit 131. The monitoring data transmission unit 121 stores the real address in the destination area 110, and the dummy address in the source area 111 to generate monitoring data 11.

The control unit 12 of this exemplary embodiment may not include the preceding data transmission unit 120, the register 122, and the second timer counter. The device 1, for example, when performing communications with another communication device by normal MAC frames, executes communication by using a real address as the address of a source. Therefore, the other communication device learns the real address of the device 1 in the MAC address table. The monitoring data 11 of this exemplary embodiment stores a real address in the destination area 110. Since the real address of the device 1 is learned in the MAC address table of the other communication device, the monitoring data 11 transmitted from the device 1 is forwarded on the other communication device, and returns to the device 1 of source.

According to each exemplary embodiment described above, link failure can be detected even when a physical link failure cannot be detected, and link failure can be detected without depending on the type of another communication device.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication device connected to a network, comprising:
a communication unit used for communications with the network;
a data transmission unit that transmits data having a first address indicating the communication unit as a destination, and a second address different from the first address as a source from the communication unit to the network; and
a reply detection unit that receives the data returned from the network to the communication unit.

2. The communication device according to claim 1,
wherein the reply detection unit, when it cannot receive the data, switches a transmission path to the network to another transmission path different from the transmission path.

3. The communication device according to claim 2,
wherein the data transmission unit, after the transmission path is switched to the another transmission path, continues to transmit the data to the network via the transmission path, and
wherein the replay detection unit, when receiving the data, switches the another transmission path to the transmission path.

4. The communication device according to claim 1, wherein the data transmission unit transmits the data according to a command indicating transmission of the data.

5. The communication device according to claim 1, comprising a preceding data transmission unit that transmits preceding data having the second address as a destination, and the first address as a source to the network,
wherein the data transmission unit, after transmitting the preceding data, transmits the data to the network.

6. The communication device according to claim 5,
wherein the preceding data generation unit transmits the preceding data at a specific interval.

7. The communication device according to claim 1, comprising:
a preceding data generation unit that transmits preceding data having the second information as a destination and the first information as a source; and
a register that stores information indicating whether the preceding data has been transmitted,
wherein the data transmission unit transmits the data when information stored in the register indicates that the preceding data has been transmitted.

8. The communication device according to claim 7, comprising a timer counter that measures time and transmits a notification signal to the preceding data generation unit at a specific interval,
wherein the preceding data generation unit, on receiving the notification signal, transmits the preceding data.

9. A communication method comprising:
step for generating data having a first address indicating a communication unit used for communications with a network as a destination, and a second address different from the first address as a source;
step for transmitting the data from the communication unit to the network; and
step for receiving the data returned from the network to the communication unit.

10. The communication method according to claim 9, further comprising:
step for switching a transmission path to the network to another transmission path different from the transmission path when the data cannot be received.

11. The communication method according to claim 10, further comprising:
step for continuing to transmit the data to the network via the transmission path after the transmission path is switched to the another transmission path,; and
step for switching the another transmission path to the transmission path when receiving the continuously transmitted data.

12. The communication method according to claim 9, further comprising:
step for transmitting the data according to a command indicating transmission of the data.

13. The communication method according to claim 9, further comprising:
step for transmitting preceding data having the second address as a destination and the first address as a source to the network; and
step for transmitting the data to the network after transmitting the preceding data.

14. The communication method according to claim 13, further comprising:
step for transmitting the preceding data at a specific interval.

15. A program product that instructs a communication device connected to a network to execute the steps of:
generating data having a first address indicating a communication unit used for communications with a network as a destination, and a second address different from the first address as a source;
transmitting the data from the communication unit to the network; and
receiving the data returned from the network to the communication unit.

16. A communication interface used for communications with a network, comprising:
a data transmission unit that transmits data having a first address indicating the communication interface as a destination, and a second address different from the first address as a source to the network; and
a reply detection unit that receives the data returned from the network to the communication interface.
